(19) United States
(12) Patent Application Publication
(10) Pub. No.: US 2020/0049644 A1
(43) Pub. Date: Feb. 13, 2020

(54) TEMPERATURE AND HUMIDITY SENSOR MODULE SENSING METHOD

(71) Applicant: SOLTEAM OPTO, INC., Taoyuan (TW)

(72) Inventors: Shang-Jung WU, Taoyuan (TW); Chun-Lin LU, Taoyuan (TW); Chia-Hung WANG, Taoyuan (TW); Chin-Feng CHEN, Taoyuan (TW)

(21) Appl. No.: 16/168,125

(22) Filed: Oct. 23, 2018

(30) Foreign Application Priority Data
Aug. 7, 2018 (TW) 107127487

(51) Int. Cl. G01N 27/12; G01K 7/22

(52) U.S. Cl. CPC G01N 27/123; G01K 7/22; G01N 27/121

(57) ABSTRACT

A temperature and humidity sensor module sensing method for enabling a temperature and humidity sensor in an electric product to provide the detected humidity message to a micro control unit for determination. According to the characteristic curve of a known humidity sensor, the micro control unit determines that the humidity value rising slope exceeds a predetermined rising slope for a specific period of time, or the relative humidity rises a predetermined percentage for a specified period of time, or a high humidity limit continues for a specific period of time, indicating that the surface of the temperature and humidity sensor is attached or condensed with water molecules. Then, the micro control unit controls the heating element to heat-dry the temperature and humidity sensor, keeping the temperature and humidity sensor in the optimal working condition.

This application claims the priority benefit of Taiwan patent application number 107127487, filed on Aug. 7, 2018.

### BACKGROUND OF THE INVENTION

### 1. Field of the Invention

The present invention relates to temperature and humidity sensor technology and more particularly, to a temperature and humidity sensor module sensing method, which enables a microcontroller to control a heater in heat-drying the temperature and humidity sensor when water molecules are attached or condensed on the surface of the temperature and humidity sensor, maintaining the temperature and humidity sensor in optimal working condition.

### 2. Description of the Related Art

The advancement of technology is to bring people a more comfortable and convenient life. This is the reason why 3C products or home appliances are constantly being introduced. Washing is a chore for people both at home and abroad, such as laundry or washing dishes. Wrinkles will occur when hands are in contact with water for a long time. Long-term contact with detergent will cause some damage to the skin of the hands. People naturally go to research and develop electric appliances, such as washing machines and dishwashers for handling things that people do not like to do. In particular, the dishwasher is a late-developed electrical product. Its cleaning ability and water-saving function are gradually recognized by the general consumers. Although the current price is still high, it is still a hot product on the market.

In the operation of a dishwasher, it is to put the dishes to be cleaned into a washing tank, and at the same time, to put appropriate detergent in the dishwasher. Thereafter, the operator operates the operation panel to set the cleaning temperature, cleaning time and cleaning mode (automatic, energy saving, strong). At this time, you can wait for the tableware to be automatically cleaned and dried. However, in order to achieve these functions, a temperature and humidity sensor must be set in the dishwasher to monitor the temperature and humidity of the cleaning tank, and the detected temperature and humidity data are transmitted back to a micro control unit for judgment and processing to complete the cleaning process. However, since the temperature and humidity sensor is disposed in a high humidity or splashing environment for a long time, it is easy to be covered by water molecules, which will cause the accuracy of the temperature and humidity sensor to be greatly reduced or even invalid. How to keep the temperature and humidity sensor in the best working condition becomes the problem that the present invention wants to solve.

### SUMMARY OF THE INVENTION

The present invention has been accomplished under the circumstances in view. It is therefore the main object of the present invention to provide a temperature and humidity sensor module sensing method, which enables a temperature and humidity sensor in an electric product to provide the detected humidity message to a micro control unit for determination. According to the characteristic curve of a known humidity sensor, the micro control unit determines that the humidity value rising slope exceeds a predetermined rising slope for a specific period of time, or the relative humidity rises a predetermined percentage for a specified period of time, or a high humidity limit continues for a specific period of time, indicating that the surface of the temperature and humidity sensor is attached or condensed with water molecules. Then, the micro control unit controls the heating element to heat-dry the temperature and humidity sensor, keeping the temperature and humidity sensor in the optimal working condition.

According to another aspect of the present invention, the micro control unit determines, according to the characteristic curve of the known humidity sensor, that the humidity value falling slope exceeds a predetermined falling slope for a specific period of time, or the relative humidity declines a predetermined percentage for a specified period of time, or the relative humidity reaches the humidity lower limit value that indicating that the surface of the temperature and humidity sensor has been well dried. At this time, the micro control unit turns off the heating element.

### BRIEF DESCRIPTION OF THE DRAWINGS

FIG. 1 is a functional block diagram of a temperature and humidity sensor module in accordance with a first embodiment of the present invention.

FIG. 2 illustrates the relative humidity versus time ratio when the heating element is turned on by the micro control unit.

FIG. 3 illustrates the relative humidity versus time ratio when the heating element is turned off by the micro control unit.

FIG. 4A is a flow chart of the temperature and humidity sensor module sensing method in accordance with the present invention (I).

FIG. 4B is a flow chart of the temperature and humidity sensor module sensing method in accordance with the present invention (II).

### DETAILED DESCRIPTION OF THE PREFERRED EMBODIMENT

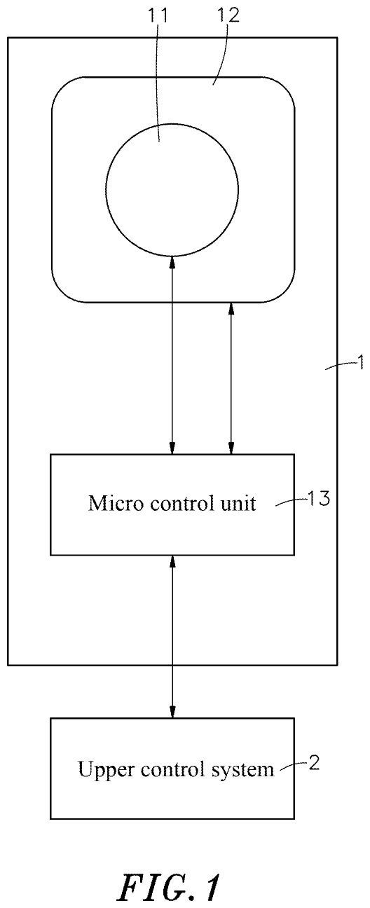

Referring to FIG. 1, a functional block diagram of a temperature and humidity sensor module sensing method in accordance with the present invention is shown. As illustrated, a temperature and humidity sensor 11, a heating element 12 and a micro control unit (MCU) 13 are mounted on a circuit board 1. The detailed explanation of each component is as follows.

The temperature and humidity sensor 11 is mounted on the circuit board 1 and adapted for detecting the temperature and humidity of the outside world. Further, the temperature and humidity sensor 11 is composed of a resistive wet sensor and a thermistor.

The heating element 12 is mounted on the circuit board 1 around the outside of the temperature and humidity sensor 11 and adapted for heating the temperature and humidity sensor 11 to evaporate water from the surface of the temperature and humidity sensor 11. Further, in this embodiment, the heating element 12 is composed of an electrical heating plate.

The micro control unit 13 is mounted on the circuit board 1 and electrically connected with the temperature and humidity sensor 11 and the heating element 12 and used to control the operation of the heating element 12, and also to monitor whether the humidity value detected by the temperature and humidity sensor 11 is lower than a predetermined reference value. If the humidity value detected by the temperature and humidity sensor 11 is not lower than a predetermined reference value, it means that the temperature and humidity sensor 11 still has water molecules remaining on the surface thereof. At this time, the micro control unit 13 controls the heating element 12 to keep heating. If the humidity value detected by the temperature and humidity sensor 11 is lower than a predetermined reference value, it means that the surface of the temperature and humidity sensor 11 has been completely dried. At this time, the micro control unit 13 controls the heating element 12 to stop heating. The micro control unit 13 is electrically connected with the temperature and humidity sensor 11, the heating element 12 and an upper control system 2 by a serial transmission interface, and the serial transmission interface refers to an Inter-Integrated Circuit, I²C, a Serial Peripheral Interface Bus (SPI) or a Universal Asynchronous Receiver/Transmitter (UART).

The aforesaid upper control system 2 refers to the main control circuit of the electrical product, and the temperature and humidity sensor module sensing method disclosed in the present invention is only a branch circuit connected in series to the main control circuit, and the upper control system 2 and the micro control unit 13 can perform signal bidirectional transmission.

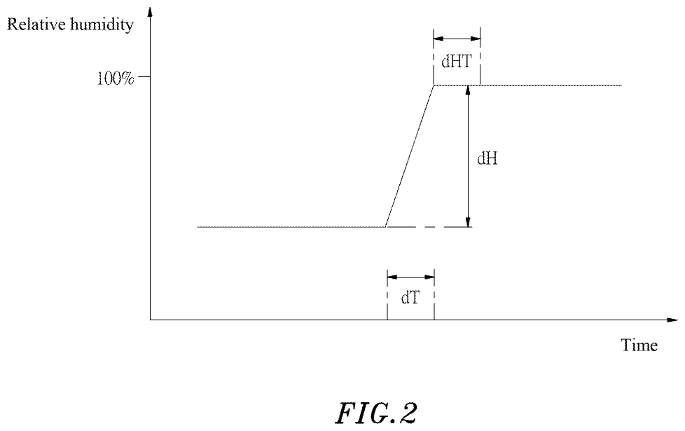

Please refer to FIG. 2, which illustrates the relative humidity versus time ratio when the heating element is turned on by the micro control unit. The temperature and humidity sensor provides the sensed humidity message to the micro control unit, and the micro control unit determines, according to the characteristic curve of a known humidity sensor, that the humidity value rising slope (dH) exceeds a predetermined rising slope for a specific period of time (dT), or the relative humidity rises a predetermined percentage for a specified period of time, or a high humidity limit (dHT) continues for a specific period of time (dT), indicating that the surface of the water and humidity sensor is attached or condensed with water molecules.

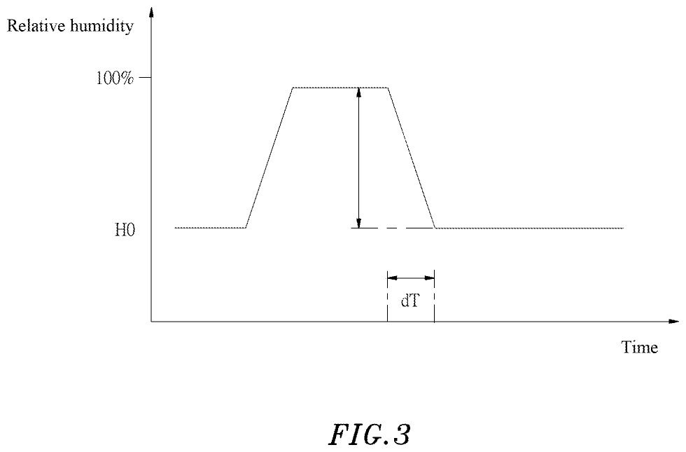

Please refer to FIG. 3, which illustrates the relative humidity versus time ratio when the heating element is turned off by the micro control unit. According to the characteristic curve of the known humidity sensor, the micro control unit determines that the humidity value falling slope (dH) exceeds a predetermined falling slope for a specific period of time (dT), or the relative humidity declines a predetermined percentage for a specified period of time (dT), or the relative humidity reaches the humidity lower limit value (Ho) that refers to the relative humidity of the outside world sensed by the temperature and humidity sensor before the electrical product is started, indicating that the surface of the water and humidity sensor has been well dried. At this time, the micro control unit turns off the heating element.

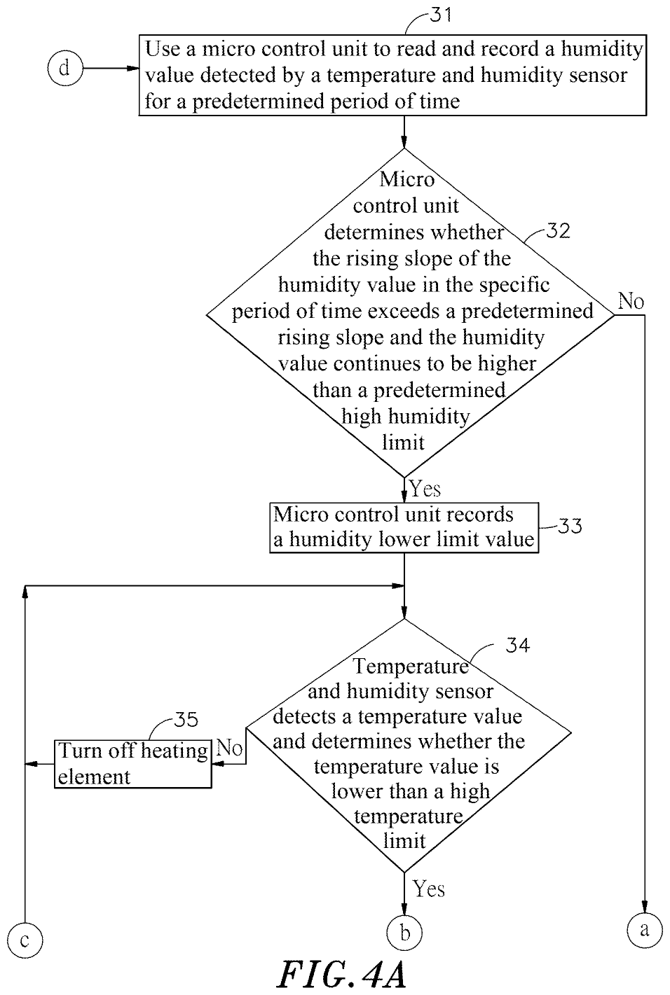

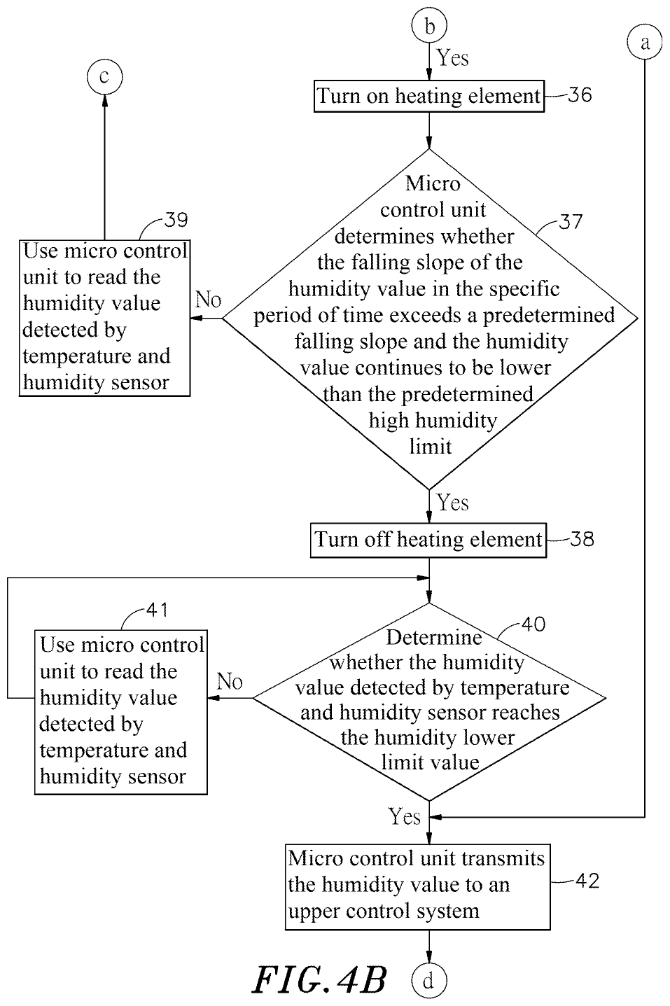

FIGS. 4A and 4B illustrate the flow charts of the temperature and humidity sensor module sensing method in accordance with the present invention. The temperature and humidity sensor module sensing method comprises the steps outlined bellows:

Step (31): Use a micro control unit to read and record a humidity value detected by a temperature and humidity sensor for a specific period of time.

Step (32): The micro control unit determines whether the rising slope of the humidity value in the said specific period of time exceeds a predetermined rising slope and the humidity value continues to be higher than a predetermined high humidity limit. If “Yes”, perform Step (33). If “No”, perform Step (42). The high humidity limit is 80% relative humidity, so the relative humidity between 80% and 100% is defined as the high humidity limit.

Step (33): The micro control unit records a humidity lower limit value (Ho) that refers to the relative humidity of the outside world sensed by the temperature and humidity sensor before the electrical product is started.

Step (34): The temperature and humidity sensor detects a temperature value for determination whether the temperature value is lower than a high temperature limit. If “Yes”, perform Step (36). If “No”, perform Step (35). The temperature and humidity sensor transmits the detected temperature value to the micro control unit. The micro control unit first determines that the detected temperature value does not exceed the high temperature limit, and then turns on the heating element, and sets the operating temperature to be within the range of 30° C. to 55° C. to effectively evaporate water molecules and to prevent damage to other electronic components on the circuit board. Therefore, define the temperature range of 30° C. to 55° C. to be the temperature at which the heating element can be turned on, and the high temperature limit is defined as 56° C. When the temperature heated by heating element exceeds 56° C., the heating element must be turned off by the micro control unit to ensure that the overall temperature and humidity sensor module can operate safely.

Step (35): Turn off the heating element, then continuously perform Step (34).

Step (36): Turn on the heating element.

Step (37): The micro control unit determines whether the falling slope of the humidity value in the said specific period of time exceeds a predetermined falling slope and the humidity value continues to be lower than the predetermined high humidity limit. If “Yes”, perform Step (38). If “No”, perform Step (39).

Step (38): Turn off the heating element, and then perform Step (40).

Step (39): Use the micro control unit to read the humidity value detected by the temperature and humidity sensor, and then perform Step (34).

Step (40): Determine whether the humidity value detected by the temperature and humidity sensor reaches the humidity lower limit value. If “Yes”, perform Step (42). If “No”, perform Step (41).

Step (41): Use the micro control unit to read the humidity value detected by the temperature and humidity sensor, and then continuously perform Step (40).

Step (42): The micro control unit transmits the humidity value to an upper control system, and then continuously perform Step (31).

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A temperature and humidity sensor module sensing method, comprising the steps of:
(a) using a micro control unit to read and record a humidity value detected by a temperature and humidity sensor for a predetermined period of time;
(b) said micro control unit determining whether the rising slope of said humidity value in said specific period of time exceeds a predetermined rising slope and said humidity value continues to be higher than a predetermined high humidity limit, and then performing step (c) if “Yes”, or step (l) if “No”;
(c) said micro control unit recording a humidity lower limit value;
(d) said temperature and humidity sensor detecting a temperature value and determining whether said temperature value is lower than a high temperature limit, and then performing step (f) if “Yes”, or performing step (e) if “No”;
(e) turning off said heating element and then continuously performing step (d);
(f) turning on said heating element;
(g) said micro control unit determining whether the falling slope of said humidity value in said specific period of time exceeds a predetermined falling slope and said humidity value continues to be lower than said predetermined high humidity limit, and then performing step (h) if “Yes”, or performing step (i) if “No”;
(h) turning off said heating element and then continuously performing step (j);
(i) using said micro control unit to read the said humidity value detected by said temperature and humidity sensor and then continuously performing step (d);
(j) determining whether the said humidity value detected by said temperature and humidity sensor reaches the said humidity lower limit value, and then performing step (i) if “Yes”, or performing step (k) if “No”;
(k) using said micro control unit to read the said humidity value detected by said temperature and humidity sensor, and then continuously performing step (j); and
(l) said micro control unit transmitting said humidity value to an upper control system, and then continuously performing step (a).

2. The temperature and humidity sensor module sensing method as claimed in claim 1, wherein said high humidity limit is 80% relative humidity.

3. The temperature and humidity sensor module sensing method as claimed in claim 1, wherein said high temperature limit is 56° C.

4. The temperature and humidity sensor module sensing method as claimed in claim 1, wherein said micro control unit is electrically connected with said temperature and humidity sensor and said heating element by a serial transmission interface.

5. The temperature and humidity sensor module sensing method as claimed in claim 4, wherein said serial transmission interface is selectively an Inter-Integrated Circuit, I²C, a Serial Peripheral Interface Bus (SPI) or a Universal Asynchronous Receiver/Transmitter (UART).

6. The temperature and humidity sensor module sensing method as claimed in claim 1, wherein said temperature and humidity sensor is composed of a resistive wet sensor and a thermistor.

7. The temperature and humidity sensor module sensing method as claimed in claim 1, wherein said heating element is composed of an electrical heating plate.
